(19) United States
(12) Patent Application Publication
(10) Pub. No.: US 2025/0219179 A1
(43) Pub. Date: Jul. 3, 2025

(54) Method and Facility for Preparing and Evaluating Batteries

(71) Applicant: Primobius GmbH, Hilchenbach (DE)

(72) Inventors: Michael Breuer, Hilchenbach (DE); Joachim Gier-Zucketto, Wurselen (DE)

(21) Appl. No.: 18/851,255

(22) PCT Filed: Mar. 28, 2023
(86) PCT No.: PCT/EP2023/057986

§ 371 Date: Sep. 26, 2024

(30) Foreign Application Priority Data
Mar. 29, 2022 (DE) 10 2022 203 084.2
Jan. 26, 2023 (DE) 10 2023 200 645.6

(51) Int. Cl. H01M 10/54; C01B 32/215; C22B 1/248; C22B 3/00; C22B 7/00; C22B 15/00; C22B 21/00; C22B 26/12; C22B 47/00

(52) U.S. Cl. CPC H01M 10/54; C01B 32/215; C22B 1/248; C22B 7/007; C22B 15/0006; C22B 15/0071; C22B 21/0007; C22B 21/0023; C22B 23/043; C22B 26/12; C22B 47/00

(57) ABSTRACT

The invention relates to a method for preparing and evaluating lithium-ion batteries, having at least one step in which the batteries (2, 10) or comminuted in the presence of an aqueous medium (12), wherein the batteries (2, 10) are comminuted with a remaining charge of maximally 30% in a comminuting device (73) while adding water (12), and the water (12) is supplied in such a quantity and at such a temperature that the mixture is not heated above a temperature of more than 40° C., preferably above 30° C., during the comminuting process. The invention also relates to a corresponding facility (71).

The present invention relates to a method for processing and recycling lithium-ion batteries comprising at least one step, in which the batteries are comminuted in the presence of an aqueous medium, and a plant for processing and recycling lithium-ion batteries, which is preferably designed to carry out the method according to the invention.

Due to the increasing use in electrically powered motor vehicles as an energy source, lithium-ion batteries will accumulate in large quantities in the near future during production and, at the end of their service life, they will accumulate as waste. These batteries are made of various valuable materials that are available as a composite. Essentially, these are:

Plastics, ferrous metals, copper, aluminium, graphite as anode material, metal oxides as cathode material, lithium, cobalt, nickel, manganese and other rare valuable materials as well as electrolyte.

About 50% of the battery modules consist of the so-called “black mass”, in which the particularly valuable raw materials are bonded, and which primarily consists of fine graphite and lithium metal oxides in a size within the range of 0.5 to 10 μm. In addition, nickel, manganese, copper and cobalt are also to be regarded as particularly valuable components.

The battery blocks are connected in such a way that controlled disassembly, for example by loosening a screw connection, is practically impossible. In addition, very different formats are commercially available. Therefore, the manufacturer's instructions must always be observed before and during the unloading and separation process. Depending on the type of battery, it can even be necessary to activate special devices within the battery to activate the battery connections in order to be able to carry out the discharge. After opening the battery and discharging, the components must be separated. The metals and plastics of the housing can be sorted separately and supplied into a recycling management, wherein suitable recycling methods are already being used here.

The remaining battery blocks consist of individual battery cells and/or modules. Depending on the design of the battery, it is possible to simply separate the cells, but there are also batteries in which the separation of the battery blocks is very complex so that, in prior art, there is no satisfactory method for recycling the blocks or also the cells. The unpleasant characteristic of these batteries is that a complete discharge is very time-consuming, and the batteries exhibit voltage, i.e., a state of charge, after a short time following a discharge cycle. A battery that is not completely discharged usually suffers a short circuit when opened, which can ignite the electrolyte due to the effect of heat. The results in unforeseeable deflagrations leading all the way up to fires.

In some of the solutions known from prior art, attempts are made to thermally recycle the batteries by recovering the metals, wherein, however, the plastics, electrolyte and lithium are completely or extensively lost. In some methods, the battery cells are comminuted and transferred directly into the wet-chemical process. The battery cells are insufficiently separated before the subsequent wet-chemical precipitation method. This doubles the amount to be processed in the wet-chemical process. Such a wet-chemical method is described, for example, in EP 3 670 686 A1.

In addition, valuable raw materials in the black mass such as lithium, graphite, nickel, cobalt and other metals, for example, are lost during thermal recycling. This results in a high load on the precipitation chemistry or the wet-chemical method due to metallic and other residual materials of the battery shells and conductors.

From DE 10 2011 082 187 A1, a method for the comminution of batteries containing LiPF₆ is known, in which the battery is subjected to a comminution process, which is carried out by means of at least one tool acting mechanically on the battery, wherein the comminution process takes place in an ambient fluid surrounding the battery, which comprises at least one alkaline earth metal. The ambient fluid is an aqueous solution containing calcium or magnesium, which are present as basic hydroxides Ca(OH)₂ or Mg(OH)₂ and react in aqueous solution with the hydrogen fluoride (HF for short) produced during the decomposition of LiPF₆ to form poorly soluble CaF₂ or MgF₂ and are bonded in this way.

Based on the above-mentioned problems of the methods known from prior art, the task of the present invention is to provide an effective method in which valuable raw materials for a recycling management can be obtained from batteries that either come from the production scrap or have reached the end of their service life.

### DESCRIPTION ACCORDING TO THE INVENTION

According to the invention, the task is solved by means of a method with the features of Patent claim 1.

The method for processing and recycling lithium-ion batteries according to the invention comprises at least one step, in which the batteries are comminuted in the presence of an aqueous medium, wherein it is provided according to the invention that the batteries are still comminuted with a residual charge of a maximum of 30% with the addition of water in a comminuting device, wherein the water is supplied in such a quantity and at such a temperature that the mixture does not heat up above a temperature of more than 40° C. during comminution, preferably not above a temperature of 30° C.

Surprisingly, it has been shown that the complete discharge of the batteries is not necessary for the subsequent separation process, which can reduce the effort involved in the preliminary process of the method. The energy gained during the partial discharge can also be favourably reused.

The addition of a sufficient amount of water during the comminution of the batteries not only prevents greater heating, but it was also surprising to find that the harmful hydrogen fluoride is not released, or at least not in a measurable concentration. Currently, it is assumed that the reaction of hydrolysis of LiPF, in pure water is very slow, as opposed to hydrolysis in contaminated electrolyte water, as shown in the following:

First, the LiPF₆ decomposes in water according to the equation:

LiPF₆→LiF+PF₅

Only in the subsequent reaction,

PF₅+H₂O→POF₃+2HF,

would hydrogen fluoride be produced.

Further favourable embodiments according to the invention are specified in the dependently formulated claims. The features listed individually in the dependently formulated claims can be combined with each other in a technologically meaningful manner and can define further embodiments according to the invention. In addition, the features specified in the claims are further specified and explained in the description, wherein further preferred embodiments according to the invention are presented.

In accordance with a preferred further embodiment of the present invention, the water is preferably supplied in relation to a quantity of 1000 kg of batteries per hour in a quantity of 20 to 200 m³/h. Due to the large and continuous volumetric flow, the heat generated during the mechanical comminution of the batteries and in the hydrolysis method is immediately dissipated. In accordance with the present invention, the comminution is therefore preferably not carried out in a standing water reservoir, but water is constantly supplied and discharged from the comminuting device in which the comminution takes place so that the heat generated in the process is also permanently dissipated.

According to the invention, for example, ordinary tap water at a temperature below room temperature can be supplied during comminution of the batteries. However, it is preferable that the water is supplied at a temperature within the range of 5° C. to 20° C.

The water management, for example, can be designed as a circulation system. For example, the water can be supplied into the comminution and/or separation process from a storage container and collected again downstream, for example, where separated particles are dried, for example, in a sieve press, and then returned to the comminution and/or separation process. In particular, filter systems can also be used to process the circulating water so that the exhaust air from a vacuum pump used in the system, for example, condenses and the condensate can be supplied back into the storage container. If further water is needed, it can be supplied from the line network (so-called make-up water). The circulating water can be monitored with regard to various parameters, such as pH value, conductivity, biocity, colour or the like for example. Where applicable, partial quantities of the circulating water can be exchanged in each case. The amount of circulating water required for the separation process according to the invention is approximately 20 to 200 m³/h/t batteries. In the case of two-step comminution, the use of at least 20 m³/h/t is recommended, preferably at least 50 m³/h/t. In the case of three-step comminution, it is preferred to use at least 50 m³/h/t of circulating water, being particularly preferred, about 100 m³/h per tonne of batteries.

Preferably, the comminution of the batteries, particularly the battery cells and/or battery modules, is carried out in at least two steps in such a way that they are initially coarsely pre-comminuted in a first step before they are comminuted more finely in a subsequent second step. The selection of the number of comminution steps, for example two, three or more such steps, depends on the size of the material introduced. For complete battery modules with a size of more than 0.5 m, for example, a three-step comminution system is favourable. For individual battery cells or smaller units with a size of less than, for example, 0.5 m, a two-step system is usually sufficient.

The clear blade width in the comminuting device used in the last comminution step is preferably less than about 12 mm, preferably less than about 9 mm. The clear blade width in the penultimate step can then be less than 25 mm, preferably about 19 mm, for example. For example, with more than two comminution steps, the clear blade width of the third-to-last step is less than about 60 mm, preferably less than about 45 mm. The specific drive power, i.e., the drive power per throughput capacity in kg/h of battery cells and/or modules for the blade shafts, is about 50 W/kg battery cells and/or modules per hour, preferably about 80 to 120 W/kg/h.

In accordance with a preferred further embodiment according to the invention, the mixture comprising the comminuted batteries, and the water is separated into a first aqueous graphite-enriched fraction, which preferably also contains the metal oxides, and a second non-aqueous graphite-depleted fraction, which may still have a residual moisture.

Being particularly preferred, separation into the first and second fractions takes place via two separate process steps in such a way that the mixture is first separated in a first process step, for example, in a friction washer.

i) into a first aqueous graphite-enriched fraction, comprising particulate components with a size of <5000 μm, preferably with a size of <4000 μm, more preferably with a size of <3000 μm, even more preferably with a size of <2000 μm, and a second non-aqueous graphite-depleted fraction comprising particulate components with a size of >5000 μm, preferably with a size of >4000 μm, more preferably with a size of >3000 μm, being more preferred, with a size of >2000 μm. For example, a shredder can be used for comminution, wherein the first fraction can then be collected in a buffer tank below this shredder and then preferably further separated. Thereby, it is preferably provided that ii) the first aqueous graphite-enriched fraction comprising the particulate components with a size of <5000 μm, preferably with a size of <4000 μm, more preferably with a size of <3000 μm, even more preferably with a size of <2000 μm, is then separated into a second process step, in particular, by means of a sieve step, into a first aqueous graphite-enriched fraction freed from the particulate components, in particular, a fraction of particles smaller than 500 μm in size and a non-aqueous graphite-depleted fraction loaded with the particulate components, in particular, a fraction of particles larger than 500 μm.

In accordance with a preferred further embodiment according to the invention, the first aqueous graphite-enriched fraction, and, where applicable, the fraction freed from the particulate components, is then preferably freed from water so that a dried graphite-containing fraction is obtained. For the purposes of the present invention, “dried” is understood to mean that the said fraction has undergone at least one drying method but still contains a residual moisture. In practice, it has been shown that this fraction can still contain an average of about 25% residual moisture after drying. The drying method can be carried out in a filter press for example. In the method according to the invention, this fraction contains a large part of the valuable black mass, which can be pressed through a filter by applying pressure and thus extensively freed from water. The pre-dried black mass can then be temporarily stored in a container.

In accordance with a preferred further embodiment of the above-mentioned variant of the method, the water obtained during the drying method can be collected, then cooled by a heat exchanger and then returned to the comminuting device and/or the mixture comprising the comminuted batteries and water. The water can have particulate components with a size of up to 500 μm, for example. Alternatively, and/or additionally, the water can also be added to the process via a friction washer located downstream from the comminuting device.

Preferably, in accordance with a further embodiment according to the invention, the second non-aqueous graphite-depleted fraction, where applicable, the second non-aqueous graphite-depleted fraction, comprising particulate components with a size of >5000 μm, preferably with a size of >4000 μm, more preferably with a size of >3000 μm, even more preferably with a size of >2000 μm is guided via a separation device, in particular, a zig-zag classifier or a zig-zag separator, and particulate components containing a bulk density of at least 0.02 kg/m³ are separated into a heavy fraction and particulate components with a maximum bulk density of 0.4 kg/m³ are separated into a light fraction. The targeted bulk density can be adjusted as required.

Preferably, the heavy fraction containing a first graphite-containing secondary fraction is supplied into another comminuting device, in particular, an impact mill, and be comminuted therein.

Preferably, the comminuted heavy fraction containing the first graphite-containing secondary fraction is still separated into pure metallic fractions. In this method, the plastics that may, where applicable, be entrained, can be collected and the entrained black mass can be supplied into the wet-chemical method.

Preferably, the aerosol produced during the separation process and/or the comminution process that contains part of the first graphite-containing secondary fraction is also aspirated and the part of the first graphite-containing secondary fraction contained therein is separated, in particular, it is filtered.

In summary, the preferred further separation process described above can be described as follows. The metals and plastics are preferably separated in a separation method that exploits the density differences, wherein transverse air currents in free fall separate the heavier metals from the lighter plastic residual materials and film residual materials. Another comminuting device, in particular, an impact mill, knocks off the black mass on the metals. An aspiration system collects the dust, which essentially consists of black mass. A sieve cascade preferably separates the components sorted according to their size. Magnetic separators can be used, for example, to separate the ferromagnetic components. The other metals can be separated from each other, for example, by exploiting the density differences with an air separation table or the like. The metals are preferably collected separately and can be supplied into a recycling management.

The lighter plastics are also preferably collected and can be supplied into a recycling management. The black mass is also preferably collected in order to be supplied into a further processing.

In accordance with a preferred further embodiment of the method according to the invention, the non-aqueous graphite-depleted fraction loaded with the particulate components is dried, by means where applicable, of a drying device, in particular, a vacuum dryer. The moist small parts with adhering black mass pass through a vacuum dryer in particular, wherein the same method steps for further separation can preferably be completed as described in the separation process above.

The vaporous condensate water produced during the drying method, for example, can first be condensed into hot water and, where applicable, then cooled down via a heat exchanger. The water then received can also be returned to the comminuting device and/or to the mixture comprising the comminuted batteries and the water.

In accordance with a favourable further embodiment of the present invention, the dried non-aqueous graphite-depleted fraction loaded with the particulate components, which can comprise a second graphite-containing secondary fraction, can preferably be supplied into another comminuting device, in particular, an impact mill, and be comminuted therein.

In this method variant, the comminuted fraction containing the second graphite-containing secondary fraction can, for example, then be separated into further pure metallic fractions. In this method, the plastics that may, where applicable, be entrained can be collected, whereas the entrained black mass can be supplied into the wet-chemical method for processing together with the rest of the black mass.

Furthermore, the further aerosol produced during the comminution process that contains part of the second graphite-containing secondary fraction is preferably aspirated, wherein the part of the second graphite-containing secondary fraction contained therein is separated, in particular, it is filtered.

In accordance with a preferred further embodiment of the method according to the invention, for the further processing of those fractions containing the main part of the black mass, preferably the dried graphite-containing fraction and/or the first and/or the second graphite-containing secondary fraction are mixed with concentrated sulphuric acid so that a graphite-containing pulp is obtained, wherein the obtained graphite-containing pulp is then filtered, for example, directly, so that graphite and sulphuric acid solution can be obtained.

The filtered graphite can then preferably be cleaned, in particular, be flushed with water. Furthermore, in this preferred variant of the method according to the invention, the sulphuric acid solution, which comprises at least one metal of the first and/or the third main group and/or at least one metal of the 7^{th} to 11^{th} secondary group, can then be wet chemically separated and/or wet chemically extracted.

According to the invention, the black mass obtained in the various separation processes described above is then preferably further processed in a wet-chemical process, in particular, dissolved by sulphuric acid, until the metals have dissolved in the acid. For example, the graphite can be separated, collected and recycled via a sieve press.

The individual metals, particularly selected from the series comprising lithium, aluminium, manganese, iron, cobalt, nickel, copper, can be precipitated, collected and supplied into a recycling management by specifically adjusting the acid concentration and/or temperature from the acid solution for example.

Acids or special intermediate products of particular interest to the basic industry can also be extracted directly from the method.

The acid is preferably circulated within a circulation system.

In summary, some preferred measures are listed below that serve the wet-chemical processing of the black mass previously obtained by the separation processes:
the black mass and the intermediate products can be dissolved by means of sulphuric acid and/or ammonia and/or water peroxide and/or water and/or organic solvents, wherein these can be used individually or as a solvent mixture;
the graphite can be separated from the liquid by a filter press;
the liquid can be further processed in a step-by-step method;
the liquid can be passed from one process step to the next process step;
the liquid is preferably circulated;
sulphuric acid, hydrogen peroxide, ammonia and/or organic solvents can be added as needed to ensure chemical reactions and pH adjustment;
the end products are ammonium sulphate and metal sulphates, which can be removed from the system for further recycling;
the gases occurring in the individual process steps can be supplied by aspiration, for example, to a filter system consisting of a wet scrubber and/or a cyclone separator and/or a filter;
the metals in the liquid can be separated from the liquid as sulphates by adjusting the pH value and/or phase separation and/or crystallization, in particular, gradually;
aluminium and iron, for example, can be separated together;
copper, for example, can be separated individually;
manganese and cobalt, for example, can first be separated together and then in a subsequent step;
nickel, for example, can be separated individually and/or
lithium can be separated individually.

When complete car batteries, which are usually designed as relatively large components, are delivered, the design and electrical connections are fundamentally different, as each car manufacturer has its own specific structure. In these cases, additional or measures modifications to the processing method can be useful. For example, the car batteries can be detected according to the manufacturer and discharged and disassembled until the individual battery cells and/or modules are separated. For this purpose, it is advisable to consult the manufacturer's documentation and, where applicable, to deactivate auxiliary devices, such as safety devices within the battery for example, for the purpose of discharging. Depending on the materials used, the battery housing is also disassembled and supplied into the recycling industry by type, as are existing conductors, insulators and other components.

For example, the discharge can take place either on the complete car battery or on the individual battery cells and/or modules after assembly. The discharge energy of the batteries is preferably recycled, for example through direct grid feed-in, buffer storage or the like for example.

In particular, the mixer shaft of the separator or shredder used in the first separation process can be operated at a speed of at least 500 rpm, preferably more than 1000 rpm, preferably with more than 1500 rpm, in order to achieve effective flow conditions and movements of the particles in the comminuting device.

For example, the vacuum dryer can be operated at a pressure of less than 900 mbar. The temperature inside the dryer should preferably be more than 100° C.

It is favourable to use a control system with process monitoring that is suitable for recording and/or monitoring the water inlet and/or the quantity of batteries, particularly the battery cells and/or battery modules, and/or the concentration of the black mass.

The connected aspiration systems preferably used in the method according to the invention can collect the dust and guide it via a filter system, comprising, for example, a wet scrubber and/or ultra-fine filter with activated carbon and/or cyclone separator, in order to reduce the burden on the environment to a minimum.

In contrast to prior art, the method according to the invention preferably does not use any setting agents for setting the LiPF₆, as described for example in DE 10 2011 082 187 A1.

The method according to the invention can be carried out either continuously or discontinuously, whereas the methods previously known from prior art are always only batch processes. The comminuting device according to the invention preferably operates continuously.

Important acids for the raw materials industry can be discharged from the wet-chemical method in accordance with a preferred further embodiment of the method. In the wet-chemical part of the method, sulphuric acid and/or ammonia are used, in particular, for the dissolving process. The setting of the temperature and the acid concentration preferably follows the precipitation rules for the respective metals one after the other in a cascade, wherein separate containers can be used depending on the setting.

Particular advantages of the method according to the invention lie, in particular, in that, where applicable, more than about 95% of the components of the black mass can be returned to the recycling industry. The metal sulphates can be obtained so pure (more than 99%) that they can be reused directly in the raw materials industry.

By comminution the batteries wet, the risk of deflagrations or even fires is reduced to a minimum. The water immediately reduces the temperature, preventing a chemical chain reaction.

Due to the mechanical/fluid separation of the black mass from the metals and plastics, the downstream method steps are loaded with significantly less material and can therefore be operated more effectively and cost-effectively. For example, most of the black mass can be supplied directly into the wet-chemical part of the method via the filter cake of a filter press, wherein vacuum drying is not necessarily required so that the method can be carried out in a very energy-efficient manner. Practically no valuable raw material is lost during the method.

The black mass adhering to the plastics cannot be removed economically due to the high van der Waals forces and thus significantly determines the proportion of material that cannot be recycled into processing.

All media used can be circulated so that the use of resources is reduced to a minimum. The energy consumption is significantly lower than with thermal separation methods due to the use of purely mechanical/fluid engineering methods.

In addition to the method described above, the object of the present invention is furthermore a plant for the processing and recycling lithium-ion batteries, which is preferably designed to carry out the method according to the invention, comprising at least one comminuting device which comprises a comminuting unit that can be flushed with an aqueous medium, wherein, according to the invention, the plant furthermore comprises at least one of the comminuting devices in the transport route downstream (first) separation device, which comprises at least one sieve, suitable for separating material obtained in the comminuting device into at least two fractions with different particle sizes.

In accordance with a preferred further embodiment according to the invention, the comminuting unit comprises at least two comminution steps arranged one below the other according to gravity.

In accordance with a preferred further embodiment according to the invention, the plant comprises at least one further separation device downstream from the first separation device in the transport route, which comprises at least one sieve, suitable for separating at least one fraction previously separated in the first separation device into at least two further fractions with different particle sizes.

In accordance with a preferred further embodiment according to the invention, at least one first separation device comprises a drying device downstream in the transport route, preferably a filter press or a vacuum dryer, for the drying of at least one fraction previously separated by means of the separation device.

In accordance with a preferred further embodiment according to the invention, at least one comminuting device is designed as an impact mill, wherein this impact mill is at least downstream from a separation device in the transport route and serves to further reduce the particles of a previously separated fraction.

In accordance with a preferred further embodiment according to the invention, the plant comprises at least one further separation device by means of which lighter and heavier particles are separated from each other by a cross-air flow in free fall, wherein this further separation device is downstream in the transport route from at least one separation device comprising a sieve.

In accordance with a preferred further embodiment according to the invention, the plant comprises at least one plant area in the transport route downstream from at least one comminuting device and downstream from at least one separation device, in which area the particles of at least one previously separated fraction are dissolved in a liquid medium and then subjected to a further separation process, wherein this plant area comprises, in particular, a device for sieving and/or pressing and/or adjusting the pH value and/or extracting and/or crystallizing.

### FIGURE DESIGNATION

The invention and the technical environment are explained in more detail below using the figures. It should be pointed out that the invention is not intended to be limited by the exemplary embodiments shown. In particular, unless explicitly stated otherwise, it is also possible to extract partial aspects of the facts explained in the figures and combine them with other components and insights from the present description and/or figures. In particular, it should be pointed out that the figures and in particular the proportions depicted are only schematic. The same reference numbers designate the same items so that explanations from other figures can be used as a supplement. The figures show:

FIG. 1 an exemplary schematic description of the preliminary process in the method according to the invention;

FIG. 2 an exemplary schematic description of the separation process as part of the method according to the invention;

FIG. 3 an exemplary schematic description of a further sub-process of the method according to the invention;

FIG. 4 an exemplary schematic description of a further sub-process of the method according to the invention;

FIG. 5 an exemplary schematic description of the chemical sub-process of the method according to the invention;

FIG. 6 a schematically simplified flow diagram of a first phase of an exemplary process according to the invention;

FIG. 7 a schematically simplified flow diagram of a subsequent separation process, which is part of the method according to the invention;

FIG. 8 a schematically simplified flow diagram of a further, subsequent separation process, which is also part of the method according to the invention;

FIG. 9 a schematically simplified flow diagram of a further, subsequent separation process, which is also part of the method according to the invention.

In the following, the sequence of an embodiment variant of the method according to the invention as well as the structure of an embodiment variant of the plant according to the invention for processing batteries for the purpose of recycling materials contained therein are explained in more detail.

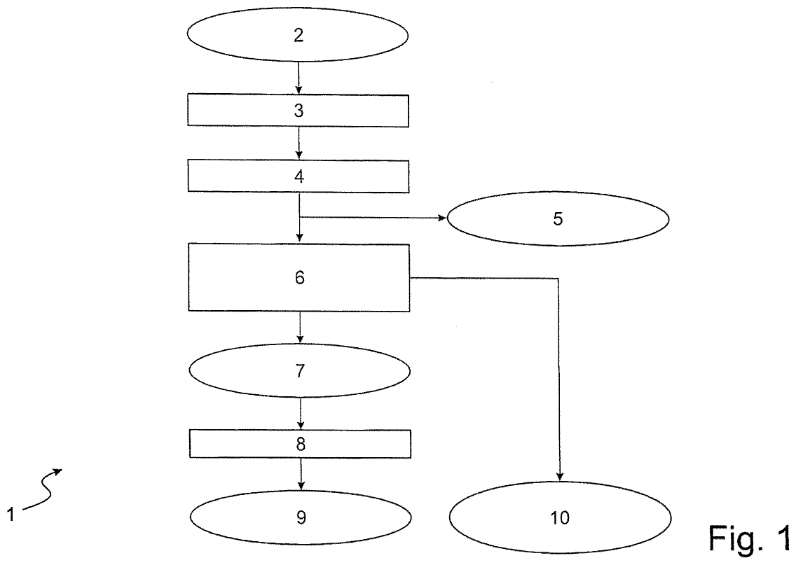

The actual method for comminution the batteries and separating the components is first preceded by a preliminary process 1, which is described in the schematic diagram in accordance with FIG. 1. In this preliminary process 1, batteries 2 from vehicles that have reached the end of their service life, for example, and, where applicable, battery cells and/or battery modules that have been sorted out during their production and require disassembly are disassembled.

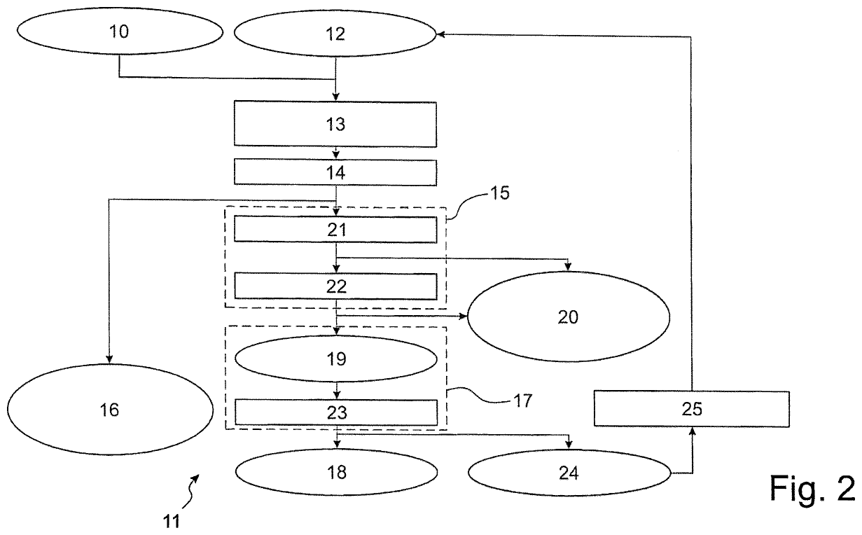

These batteries, battery cells and/or battery modules 2, which are understood in the following under the general term batteries 2, are, where applicable, after identification of the type (step 3), discharged (step 4) once, wherein, however, according to the invention, no complete discharge is deliberately provided, since this—as already explained—is very costly. In addition, it was surprisingly found that a complete discharge is not necessary for the subsequent processing method. As a result, a much larger quantity of batteries 2 per unit of time can be processed and recycled in addition to the method known from prior art, which can significantly increase the productivity of a corresponding plant. The electrical energy 5 obtained during the partial discharge of the batteries 2 can be used for other purposes. The other components 7 of batteries 2 that accumulate during disassembly 6, such as, in particular, the housing, cabling, fittings and the like, are sorted and supplied into a recycling management. For this purpose, the different materials are separated from each other and sorted (step 8), wherein the residual materials 9, which are then separated by type, can then be recycled. The batteries, battery cells and/or battery modules 10 separated from batteries 2 in this preliminary process are then supplied into the first sub-process 11, which is described in FIG. 2 and is explained below on the basis of this illustration.

The isolated batteries, battery cells and/or battery modules, which are hereinafter understood under the general term “isolated batteries 10”, are first mixed with water 12 and preferably comminuted in a multi-step comminution process 13, for example, by means of a shredder. The water 12 is constantly supplied and serves, among other things, to dissipate the heat generated in the process so that hydrogen fluoride (HF for short) is not released. After the comminution process or step 13, the mixture comprising the comminuted batteries and the water can be separated into a first aqueous graphite-enriched fraction 15 and a second non-aqueous graphite-depleted fraction 16 (separation step 14), for example by centrifuging the mixture.

The first aqueous graphite-enriched fraction 15 obtained in accordance with the separation step 14, which contains the predominant fraction of the black mass, preferably comprises particulate components with a size of <3 mm, whereas the second non-aqueous graphite-depleted fraction 16 preferably comprises particulate components with a size of >3 mm. The first aqueous graphite-enriched fraction 15 can be directly freed from the water in accordance with a drying step 17 so that a dried graphite-containing fraction 18, which contains the predominant part of the black mass, is obtained.

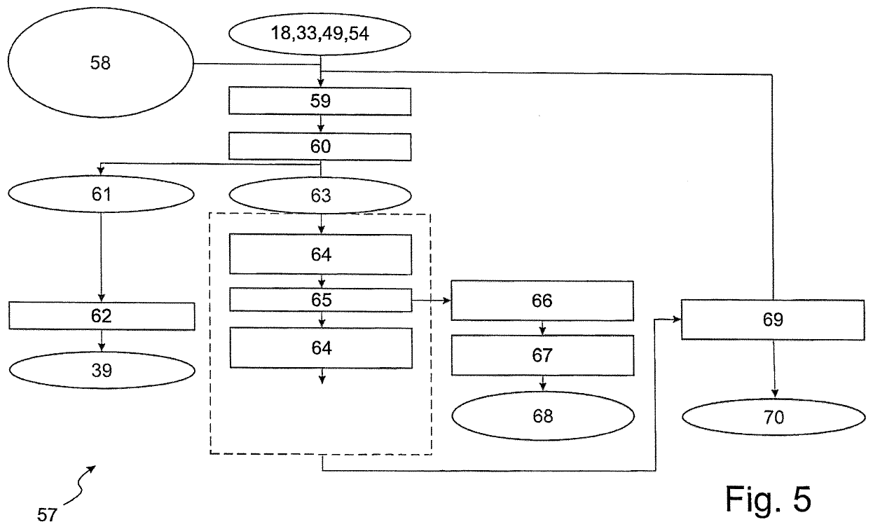

In the sense of the present invention, “black mass” is understood to mean the mostly valuable raw materials which can subsequently be separated in a wet-chemical method, as shown in accordance with FIG. 5.

However, the first aqueous graphite-enriched fraction 15 can also be separated into a first aqueous graphite-enriched fraction 19, which is freed from the particulate components, and a non-aqueous graphite-depleted fraction 20, which is loaded with the particulate components. For example, this can be sieved in a plurality of steps, first coarsely (step 21) and then finely (step 22) in order to obtain the non-aqueous graphite-depleted fraction 20 loaded with the particulate components. The first aqueous graphite-enriched fraction 19, which has been freed from the particulate components, can then be freed from the water, for example, via pressing (step 23). The contaminated water 24 can, after it has been purified and processed, where applicable, by suitable measures (step 25), returned to the water cycle and reused in the process.

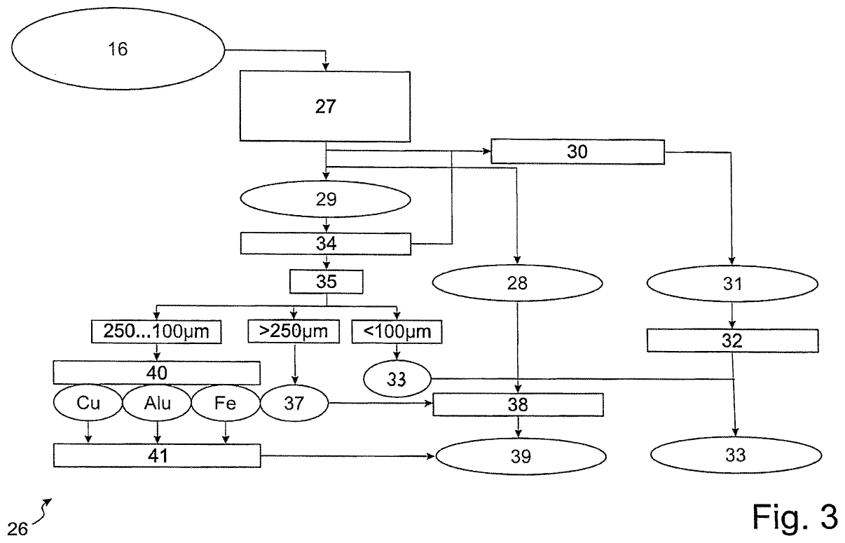

The second non-aqueous graphite-depleted fraction 16, which may contain, for example, still moist small particles with a particle size within the range of about 3 mm to about 10 mm as well as foils and metals, is supplied into a second sub-process 26 for processing, which is shown in FIG. 3 and is explained in more detail below on the basis of this illustration.

In accordance with FIG. 3, the second non-aqueous graphite-depleted fraction 16 is separated into a light and a heavier fraction 28, 29 by means of a further separation step 27, for which one can use, for example, a cross-air flow when the particles are in free fall. The aerosol 31 produced during the separation step or method 27 and containing a part of a first graphite-containing secondary fraction 33 can be removed from separation step 27 by a aspiration step 30 and filtered via a separation step 32 so that the part of the first graphite-containing secondary fraction 33 contained therein is separated, or, in particular, it is filtered.

The heavier metallic particles (heavy fraction 29), which contain the main part of the first graphite-containing secondary fraction 33, can be supplied into a comminuting device, in particular, an impact mill 34, after the separation described above in accordance with separation step 27, in which further comminution takes place. The different fractions obtained in this way can then be separated from each other by a sieving process 35, namely into a first intermediate fraction with particles within the range of about 250 μm to about 100 μm, a coarser fraction with particles in the magnitude of more than 250 μm and a third finer fraction with particles in the magnitude of less than 100 μm. The third, finer fraction then comprises the main part of the first graphite-containing secondary fraction 33, which is combined with the black mass fraction produced after passing through the separation step or filter system 32 and can also be supplied into the wet-chemical process (see FIG. 5).

The coarser fraction shown in FIG. 3 (>250 μm) usually contains mainly plastics 37. This can be collected 38 and returned to a circular economy 39, as is also shown in FIG. 3. The middle fraction, on the other hand, can be further separated by means of an air separation table and/or a magnetic separator 40, for example, in order to collect the metals copper, aluminium and iron by type 41.

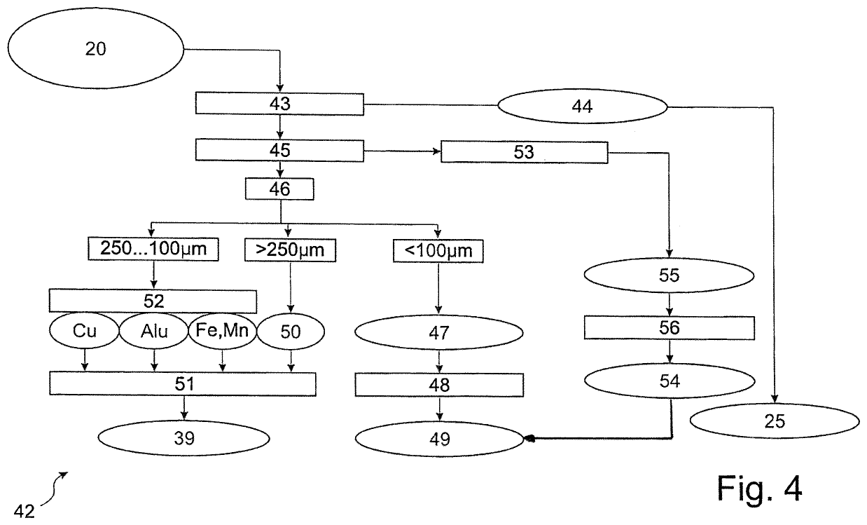

FIG. 4 shows a third sub-process 42, which describes the further processing of the non-aqueous graphite-depleted fraction 20 loaded with the particulate components (see FIG. 2). Reference is made to this below.

This fraction 20 can first be dried in a drying device, in particular in a vacuum dryer 43, wherein the condensate water 44 produced in this method can be supplied into the water circuit 25. After the drying device 43, the material can be supplied into a comminuting device, in particular an impact mill 45, in which further comminution takes place. The comminution step is then followed by a sieving process 46 for the separation of the fractions obtained in this method. The plurality of fractions (for example, three) can be of the same order of magnitude as in the sieving process 35 described earlier in FIG. 3. By means of the sieving process 46, for example, a first intermediate fraction can be obtained comprising particles with a magnitude of about 250 μm to about 100 μm, a coarser fraction comprising particles in the magnitude of more than 250 μm, and a third finer fraction comprising particles in the magnitude of less than 100 μm. This third, finer fraction comprises a further fraction containing black mass 47, which may contain water in the present case. The water can be removed by means of a separation step, for example by sieving and pressing 48. The then dried black mass fraction 49 (=second graphite-containing secondary fraction) can initially be combined directly or, where applicable, with the other fractions 18, 33 and then supplied into the wet-chemical process (see FIG. 5).

The coarser fraction (>250 μm) usually contains mainly plastics 50. This can be collected by type (step 51) and also supplied into a recycling management 39. The middle fraction, on the other hand, can be further separated by means of an air separation table and/or a magnetic separator 52, for example, in order to collect the metals copper, aluminium and iron by type and also feed them into a recycling management 39.

The aerosol 55 produced during comminution step 45 that contains part of the second graphite-containing secondary fraction 49 can be aspirated from it via an aspiration step 53 and filtered via a separation step 56 so that the part of the second secondary graphite-containing fraction 49 contained therein is separated, in particular, it is filtered. The black mass fraction 54 produced after passing through the separation step or filter system 56 can also be combined directly or, where applicable, with the other fractions 18, 33, 49 and then supplied into the wet-chemical processing (see FIG. 5).

In the following, the method of wet-chemical processing (fourth sub-process 57) of the various black mass-containing fractions 18, 33, 49, 54 is explained in more detail on the basis of FIG. 5.

The individual or possibly combined fractions containing black mass 18, 33, 49, 54 can be brought into solution by means of aqueous sulphuric acid, ammonia, hydrogen peroxide and/or organic solvents 58 (step 59) for example and then subjected to a sieving and/or filtering process 60.

Graphite 61 can be separated, collected 62 and returned to the circular economy 39. The metals 63 obtained after this separation are in a solution, the pH value of which can be adjusted accordingly depending on the metal (step 64) where applicable. Extraction 65 can then be carried out, in which the metals can be extracted and crystallized or re-extracted, for example, as metal sulphates. Adjusting the pH value (step 64) depending on the metal and extracting can be done in a plurality of steps. Afterwards, the metal sulphates 66 of the individual metals of each step can be separated and collected by type (step 67) and thus obtained as raw materials 68 for basic industry. Superfluous ammonium sulphate 69 can be discharged and recycled 70 as shown in FIG. 5.

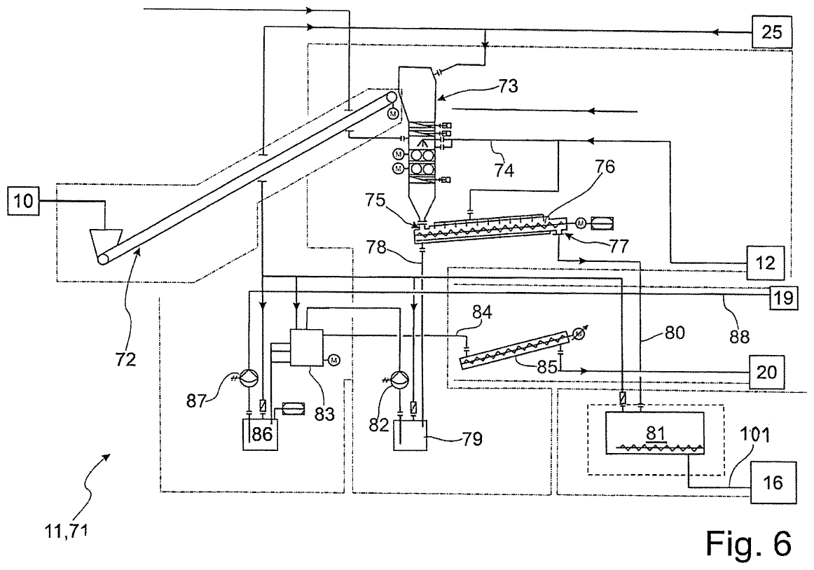

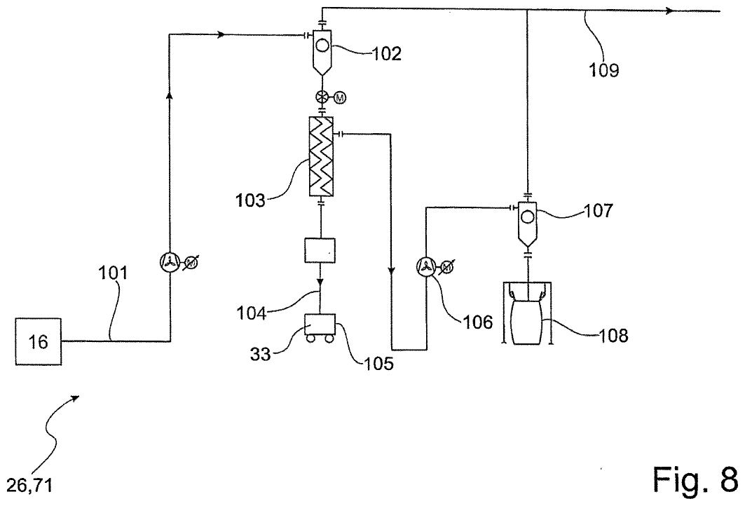

In the following, an exemplary structure of a plant 71 for the separation process described above is described in detail on the basis of a plurality of schematic flow diagrams, initially with reference to FIG. 6. As already explained, the batteries 2 are first sorted out, disassembled and discharged in the preliminary process 1. The individual batteries, battery cells and/or battery modules 10 then received are supplied to a comminuting device 73, for example a shredder, via a conveying device, in particular a conveyor belt 72 ascending in the conveying direction and are comminuted in this as a whole in two steps with the addition of water 12. For this comminution process, water 12 is continuously supplied to the comminuting device 73 via a line 74, which enters the interior of the comminuting device 73 via an access. Below the lower end of the comminuting device 73 is the input end 75 of a friction washer 76, which includes a screw conveyor equipped with paddles. The friction washer 76 comprises a sieve located below the inclined screw conveyor. When the comminuted material, in particular the mixture comprising the comminuted batteries and the water, is conveyed by means of the screw conveyor from the input end 75 to the axially opposite output end 77 of the screw conveyor (from left to right in the drawing), then the finer material with a particle size of less than 1 to less than 3 mm, for example, (e.g., the first aqueous graphite-enriched fraction 15) falls through the sieve and passes through a line 78 below the input end 75 into a buffer tank 79. The coarser material with a particle size of more than 1 to more than 3 mm, for example (e.g., the second non-aqueous graphite-depleted fraction 16), on the other hand, is transported via the screw conveyor arranged in the friction washer 76 to its output end 77, falls down via the opening there and first reaches a silo 81 via line 80, from which it is supplied to the second sub-process 26. This will be explained in more detail later with reference to FIG. 8.

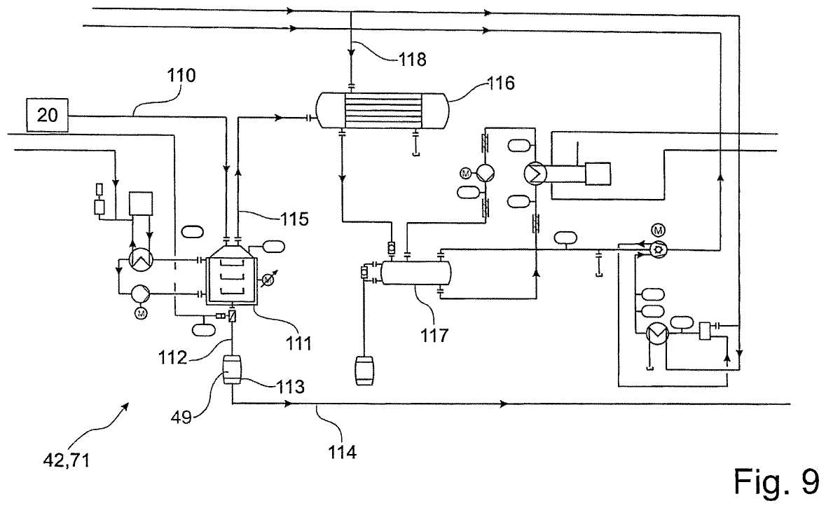

The fraction of the finer particles, for example from less than 1 to less than 3 mm, is conveyed by means of a pump 82 to a sieve 83, by means of which a further separation is made into the two fractions 19, 20, namely a fraction 19 with a particle size of less than, for example, 500 μm, which contains the largest part, for example, containing about 95% of the black mass and about 5% metals and a fraction 20 with a particle size of more than, for example, 500 μm, which contains metals such as copper and aluminium as well as plastics with adhering black mass. This fraction 20 is supplied via line 84 and screw conveyor 85 to the third sub-process 42, which will be explained in more detail later with reference to FIG. 9.

The separation process 11 shown as an example in the plant 71 can therefore be summarised as follows. The shredder 73, to which water 12 and individual batteries, battery cells and/or modules 10 are supplied, also serves as a separator in which the materials are first separated. Water is supplied to the shredder 73 in order to essentially remove the black mass from the other components of the individual batteries 10 and then transport them away. The shredder 73 is a extensively closed container, which is combined with the housing of the friction washer 76, which is located under the container and in which the screw conveyor is located.

The combined device has two offset outlets. The first outlet, which is located in the entrance area 75 of the friction washer 76, is connected to line 78. The second outlet, which is located in the output region 77 of the friction washer 76, is connected to line 80. The mesh size of the sieve of the friction washer 76, which is located around the screw conveyor, can be used to determine the size of the smaller particles that allow the sieve to pass to the first outlet.

In the shredder 73, the small parts are swirled in the water so that the black mass is flushed off. Due to the collision of the small parts with the housing of the shredder 73 and the flow guides during the transport of the particles in the device, the black mass is additionally removed from the battery parts. The screw conveyor in the friction washer 76 below the shredder 73 comprises at least one mixer shaft with radially arranged levers, which, due to their shape, force a direction of movement from the input end 75 to the output end 77 with the second outlet in addition to the turbulence. Due to the separation process in the shredder/separator 73, the metal and plastic parts leave the device via the second outlet in the output region 77 of the screw conveyor, while the black mass falls through the sieve with the water and leaves the device via the first outlet in the input area 75 of the screw conveyor. The further separation of this material is then carried out via the further sieve 83, through which larger particles, particularly plastic particles with a size of more than 500 μm, for example, are separated from the black mass transported in the water. The mesh size of the additional sieve 83 can vary so that, for example, smaller particles within the range of about 100 μm to about 1 mm, preferably within the range of about 100 μm to about 500 μm, are separated.

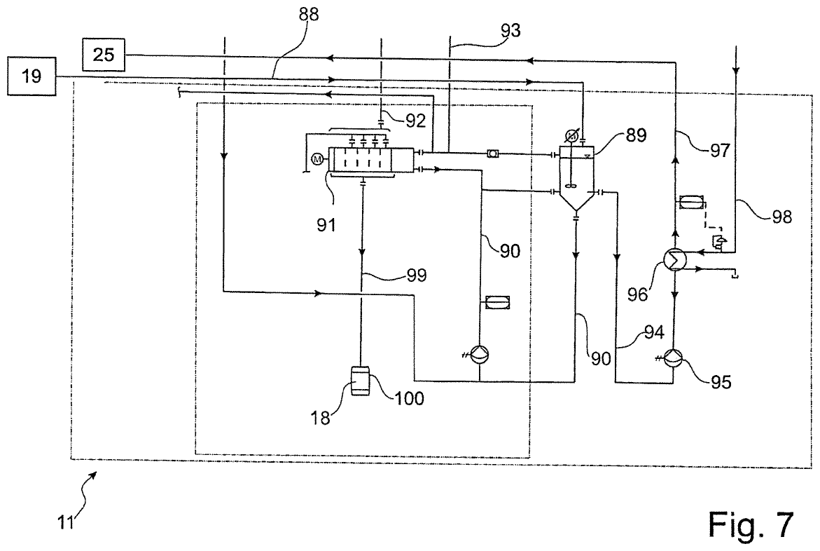

The finer fraction of particles with a size of less than 500 μm enters the tank 86 and is then supplied by means of another pump 87 via line 88 to a further separation process of the first sub-process 11, which is explained in more detail below with reference to FIG. 7.

In accordance with the flow diagram of FIG. 7, this finer fraction 19 is conveyed through line 88 into a circulation tank 89 equipped with a stirrer, wherein a partial flow leaves this circulation tank 89 via line 90 and is conveyed to a filter press 91, where drying takes place by separating water. Organic waste gases can be used for heating, which are supplied to the filter press 91 via line 92. In addition, compressed air is supplied to the filter press 91 via line 93. A partial flow of this particle fraction diluted with water can be conveyed via line 94 by means of pump 95 through a heat exchanger 96 and from there returned to the process in accordance with FIG. 6 via the return line 97. Hot tap water flows through the heat exchanger 96 in a counter-current, which reaches the heat exchanger 96 via line 98 so that the recirculated material flow can be preheated in this way. The product of the process shown in FIG. 7 is the dried black-mass-containing fraction 18, which leaves the filter press 91 via line 99 and can be temporarily stored in a barrel 100. Here, the black mass is already present in a quite high degree of purity of about 95%, for example, wherein it comprises a residual moisture within the range of about 20% to 30%. This black-mass-containing fraction 18 can be used as input material for a further wet-chemical processing method, which is shown in FIG. 5 and has already been described above.

In the following, the further separation process 26 concerning the fraction of the coarse material 16 resulting from the first shredder process in accordance with FIG. 6 is explained in more detail with reference to FIG. 8. This separation process 26 is primarily used to separate the separator foil of the separated batteries 10 from the plastic and metal particles. The coarse fraction from silo 81 first reaches a cyclone 102 via line 101, in which centrifugal force separation takes place. The fraction is then supplied to a zig-zag separator 103, in which the metals and plastics are separated using a method that exploits the density differences. In free fall, transverse air currents separate the heavier metals from the lighter plastic residual materials and film residual materials. The black mass on the metals can then be pulverized in an impact mill, as has already been explained in FIG. 3. This can then be transferred via line 104 to a transport container 105 and then supplied to the wet-chemical process. The lighter plastic particles can be supplied into another cyclone 107 via a blower 106 and the particles separated there can be collected in a container 108. The waste gas from the two cyclones 102, 107 can be discharged via line 109 and supplied into a cleaning method, such as a scrubber or the like, for example.

The medium-coarse fraction 20 separated in the separation process in accordance with FIG. 6 with particles of more than 500 μm up to a size of about 2 to 3 mm, which mainly contains copper, aluminium, iron, plastics and adhering black mass, is further processed in the method in accordance with FIG. 9, which is explained in more detail below. Via the supply line 110, this material reaches a vacuum dryer 111, where it is dried. The obtained dry black mass fraction 49 can be supplied from the vacuum dryer 111 via line 112 to a barrel 113 in which it is collected. From there, this black mass fraction 49 can be supplied via the output line 114 to the black mass fractions obtained in the other separation processes and processed by wet chemistry, as already described with reference to FIG. 5. The water vapour separated in the vacuum dryer 111 can be supplied to a condenser 116 via line 115 and condensed there and then collected in the condensate tank 117. Industrial cooling water can be used to cool the steam, which is supplied to the condenser 116 via the line 118.

### REFERENCE LIST

1 preliminary process
2 batteries/battery cells/battery modules
3 identification step
4 discharge step
5 energy
6 disassembly
7 components of the battery
8 separation and/or sorting step
9 sorted residual materials
10 separated batteries/battery cells/battery modules
11 first sub-process/separation process
12 water
13 comminution process
14 separation step
15 first aqueous graphite-enriched fraction
16 second non-aqueous graphite-depleted fraction
17 drying step
18 dried graphite-containing fraction/black-mass-containing fraction
19 first aqueous graphite-enriched fraction freed from particulate components
20 non-aqueous graphite-depleted fraction loaded with particulate components
21 sieving step
22 sieving step
23 pressing step
24 contaminated water
25 water processing step/water cycle
26 second sub-process/separation process
27 separation step/separation device
28 light fraction
29 heavy fraction
30 aspiration step
31 aerosol containing first graphite-containing secondary fraction
32 separation step/filter system
33 first graphite-containing secondary fraction (black-mass-containing fraction)
34 comminuting device/impact mill
35 sieving process
37 plastics
38 collecting
39 recycling management
40 air separation table/magnetic separator
41 collecting
42 third sub-process
43 drying device/vacuum dryer
44 condensate water
45 comminuting device/impact mill
46 sieving process
47 further black mass fraction
48 separation step/sieving and pressing
49 dried black mass fraction/second graphite-containing secondary fraction (black-mass-containing fraction)
50 plastics
51 collecting
52 air separation table/magnetic separator
53 aspiration step
54 black mass fraction
55 second graphite-containing secondary fraction containing aerosol
56 separation step/filter system
57 fourth sub-process
58 solvent
59 dissolving
60 sieving and/or filtering process
61 graphite
62 collecting
63 metallic solution
64 pH-value adjustment
65 extracting
66 metallic sulphates
67 collecting
68 raw materials
69 ammonium sulphate
70 recycling
71 plant
72 conveying device/conveyor belt
73 comminuting device/shredder
74 line
75 input end
76 separation device/friction washer
77 output end
78 line for the first aqueous graphite-enriched fraction
79 buffer tank
80 line for the second non-aqueous graphite-depleted fraction
81 silo
82 pump
83 separation device/sieve
84 line for the non-aqueous graphite-depleted fraction loaded with the particulate components
85 screw conveyor
86 tank
87 pump
88 line for the first aqueous graphite-enriched fraction freed from particulate components
89 circulation tank
90 line
91 filter press
92 line
93 line
94 line
95 pump
96 heat exchanger
97 return line
98 line
99 line for the dried graphite-containing fraction
100 barrel
101 line
102 cyclone
103 separation device/zig-zag separator
104 line, heavy fraction
105 transport containers
106 blower
107 cyclone
108 container
109 line for waste gas
110 supply line for the non-aqueous graphite-depleted fraction loaded with the particulate components
111 vacuum dryer
112 line
113 barrel
114 output line for black mass
115 line to condenser
116 condenser
117 condensate tank
118 line for cooling water

1. Method for the processing and recycling lithium-ion batteries comprising at least one step in which the batteries are comminuted in the presence of an aqueous medium, wherein the batteries are comminuted with a residual charge of no more than 30% with the addition of water in a comminuting device, wherein the water is supplied in such a quantity and at such a temperature that the mixture does not heat up above a temperature of more than 40° C. during comminution, preferably not above a temperature of 30° C.

2. The method of claim 1, wherein the water is supplied in a quantity of 20 to 200 m³/h per hour based on a quantity of 1000 kg batteries.

3. (canceled)

4. (canceled)

5. The method of claim 1, wherein the mixture comprising the comminuted batteries and the water is separated into a first aqueous graphite-enriched fraction, which optionally can also contain metal oxides, and a second non-aqueous graphite-depleted fraction.

6. The method of claim 5, wherein separation into the first and second fractions takes place over two separate process steps in such a way that the mixture is first separated in a first process step
i) into a first aqueous graphite-enriched fraction, comprising particulate components with a size of <5000 μm, preferably with a size of <4000 μm, more preferably with a size of <3000 μm, even more preferably with a size of <2000 μm, and a second non-aqueous graphite-depleted fraction comprising particulate components with a size of >5000 μm, preferably with a size of >4000 μm, more preferably with a size of >3000 μm, even more preferably with a size of >2000 μm, and optionally,
ii) the first aqueous graphite-enriched fraction comprising the particulate components with a size of <5000 μm, preferably with a size of <4000 μm, more preferably with a size of <3000 μm, even more preferably with a size of <2000 μm, is then separated in a second process step into a first aqueous graphite-enriched fraction freed from the particulate components and a non-aqueous graphite-depleted fraction loaded with the particulate components fraction.

7. The method of claim 5, wherein the first aqueous graphite-enriched fraction, and optionally the fraction freed from the particulate components, is freed from water so that a dried graphite-containing fraction is obtained.

8. The method of claim 7, wherein the water obtained is collected, then cooled by a heat exchanger and then returned to the comminuting device and/or the mixture comprising the comminuted batteries and the water.

9. The method of claim 5, wherein the second non-aqueous graphite-depleted fraction, optionally the second non-aqueous graphite-depleted fraction comprising particulate components with a size of >5000 μm, preferably with a size of >4000 μm, more preferably with a size of >3000 μm, even more preferably with a size of >2000 μm via a separation device, in particular a zig-zag separator and separated into a heavy fraction particulate components with a bulk density of at least 0.02 kg/m³ and particulate components containing a light fraction with a maximum bulk density of 0.40 kg/m³.

10. The method of claim 2, wherein the heavy fraction containing a first graphite-containing secondary fraction is supplied into a further comminuting device, in particular, an impact mill, and be comminuted therein.

11. The method of claim 10, wherein the comminuted heavy fraction containing the first graphite-containing secondary fraction is separated into pure metallic fractions.

12. The method of claim 9, wherein the aerosol produced during the separation process and/or the comminution process that contains a part of the first graphite-containing secondary fraction is aspirated and the part of the first graphite-containing secondary fraction contained therein is separated, in particular, it is filtered.

13. The method of claim 6 the non-aqueous graphite-depleted fraction loaded with the particulate components is dried, optionally by means of a drying device, in particular, a vacuum dryer.

14. The method of claim 13, wherein the vaporous condensate water produced during the drying method is first condensed into hot water and, optionally, then cooled by a heat exchanger.

15. The method of claim 13, wherein the dried non-aqueous graphite-depleted fraction loaded with the particulate components, comprising a second graphite-containing secondary fraction, is supplied to a further comminuting device, in particular, an impact mill, and comminuted.

16. The method of claim 15, wherein the comminuted fraction containing the second graphite-containing secondary fraction is separated into further pure metallic fractions.

17. The method of claim 15, wherein the aerosol -produced during the comminution process and containing a part of the second graphite-containing secondary fraction is aspirated and the part of the second graphite-containing secondary fraction contained therein is separated, in particular, it is filtered.

18. The method of claim 7, wherein the dried graphite-containing fraction and/or the first and/or the second graphite-containing secondary fraction is mixed with concentrated sulphuric acid so that a graphite-containing pulp is obtained, and the graphite-containing pulp obtained is directly filtered so that graphite and a sulphuric acid solution are obtained.

19. (canceled)

20. The method of claim 18, wherein the sulphuric acid solution comprising at least one metal of the first and/or third main group and/or at least one metal of the 7^{th} to 11^{th} secondary group is wet chemically separated and/or wet chemically extracted.

21. A plant for processing and recycling batteries containing lithium, wherein the plant is preferably designed to carry out the method according to any one of the preceding claims, comprising at least one comminuting device which has a comminuting unit that can be circulated with an aqueous medium, wherein the plant furthermore comprises at least one first separation device downstream from the comminuting device in the transport route, which comprises at least one sieve, suitable for separating material obtained in the comminuting device into at least two fractions with different particle sizes.

22. (canceled)

23. The plant of claim 21, wherein at least one first separation device has a further separation device downstream in the transport route, comprising at least one sieve, suitable for separating at least one fraction previously separated in the first separation device into at least two further fractions with different particle sizes.

24. The plant of claim 21, wherein at least one first separation device comprises a downstream drying device, preferably a filter press or a vacuum dryer, for the drying of a fraction previously separated by means of the separation device.

25. The plant of claim 21, wherein at least one comminuting device is designed as an impact mill, wherein this impact mill is downstream from at least one separation device in the transport route and serves to further reduce the particles of a previously separated fraction.

26. The plant of claim 21, wherein it comprises at least one further separation device by means of which lighter and heavier particles are separated from each other by a cross-air flow in free fall, wherein this further separation device is downstream from in the transport route of at least one separation device comprising a sieve.

27. The plant of claim 21, wherein it comprises at least one plant area in the transport route downstream from at least one comminuting device and downstream from at least one separation device in which area the particles of at least one previously separated fraction are dissolved in a liquid medium and then subjected to a further separation process, wherein this plant area, in particular, comprises a device for sieving and/or pressing and/or adjusting the pH value and/or extracting and/or crystallization.
